(19) United States
(12) Patent Application Publication
(10) Pub. No.: US 2009/0327046 A1
(43) Pub. Date: Dec. 31, 2009

(54) METHOD AND APPARATUS FOR INTERACTING WITH A USER OVER A NETWORK

(75) Inventor: Robin Caller, London (GB)

Correspondence Address: PARK, VAUGHAN & FLEMING LLP, 2820 FIFTH STREET, DAVIS, CA, 95618-7759, US

(73) Assignee: GOALLOVER LIMITED, London (GB)

(21) Appl. No.: 12/524,789

(22) PCT Filed: Jan. 28, 2008
(86) PCT No.: PCT/GB2008/000285

§ 371 Date: Jul. 28, 2009

Related U.S. Application Data
(60) Provisional application No. 60/898,320, filed on Jan. 29, 2007.

(51) Int. Cl. G06Q 10/00; G06Q 50/00

(52) U.S. Cl. 705/10

(57) ABSTRACT

One embodiment of the invention provides a method for interacting with a user over a network. The method includes receiving a request from a user machine for a content page at a publisher web-site. The user machine is provided with an interstitial page including one or more fields for collecting information about the user and two or more user response options for selection by the user, including at least a positive response and a negative response. The selected user response to the interstitial page is received and recorded, along with any information collected about the user. The recorded information may be used in a future determination of an interstitial page to provide to the user machine.

### FIELD OF THE INVENTION

The invention relates to interacting with a user over a network such as the Internet.

### BACKGROUND OF THE INVENTION

There are two main forms of advertising in widespread use on the worldwide web. The first is commonly referred to as banner advertising. A banner advert is displayed in conjunction with a page of content. In other words, a user accesses a content page from a publisher. A banner advert is provided to the user for display on the same screen as the requested content, for example as a banner across the top of the page (hence the name). The banner advert may be injected onto the page by a third party provider, such as Doubleclick (acquired by Google in 2007).

The banner advert generally provides an advertising message (e.g. text, image or animation) in respect of a product or service. The banner advert also acts as a link to a web-site run by the advertiser, so a user can click on the banner advert if they want to proceed further in respect of the advertised product, for example, to make a purchase or to acquire more information.

The second common form of advertising on the worldwide web is through the use of sponsored links for search engines. When a user enters a search query into a search engine such as Google, Yahoo or AltaVista, they receive in return not only the list of best hits for the search query, but also a set of sponsored links. In general the sponsored links are presented in a similar format to the main search results, but are separately located, for example above and/or to the side of the main search results. As with a banner advert, a user can click on a sponsored link if they want to proceed further in respect of the advertised product.

An important concern for advertisers is whether they can target their adverts. In a search engine environment, this targeting is based on the search query entered by the user. In particular, advertisers pay (bid) to be associated with particular search terms. For example, a company that provides airport parking might want a sponsored link for the search query “Heathrow parking”. A company that provides taxi travel to airports (as an alternative to parking at the airport) might also want to sponsor a link for the same search query.

Various forms of targeting are also available with banner adverts. One possibility is to link an advert to the main subject matter of the content of the page (this is referred to as contextual advertising). For example, a banner advert for a car might be displayed on pages of a web-site that provides car price information. If the user has registered to access the content, more sophisticated targeting of advertising can be achieved (subject to data protection laws), based on details held about the user, such as age and occupation (this is referred to as demographic advertising).

Both banner adverts and sponsored links are normally operated on a pay per click (PPC) basis. Thus if a user clicks on a banner advert, this first sends a message to the web-site of the content publisher (or the party responsible for displaying the advertisement in conjunction with the content page. The user is then redirected to the web-site of the advertiser. Sponsored links work in a generally similar fashion, whereby a user clicking on a sponsored link is redirected from the search engine to the web-site of the sponsor. For each such redirection, the content publisher or search engine, as appropriate, charges a fee to the advertiser.

In some situations, a banner advert or sponsored link may operate on a pay-per-view basis, whereby the advertiser pays a certain amount every 1000 times (say) that an advert or link is downloaded to a user. In this arrangement, the number of views served is independent of user action in clicking on the advert or link. A pay per view approach can provide a more predictable return to a publisher (or search engine), but conversely is more remote from the ultimate business objectives of the advertiser. Note that a pay-per-view arrangement may be used instead of or as well as a PPC scheme.

Although the provision of advertising on the Internet has been successful (especially for Google), there are some limitations on existing services. For example, sponsored links are fairly closely associated with the search terms entered by a user. Accordingly, sponsored links are well-suited to particular certain products, but are less suited to raising general awareness of a brand.

In addition, current facilities usually provide only limited information for targeting advertisements. For example, someone might enter a search string for “Holiday Greece”, but the type of holiday of interest to that person may depend significantly on factors such as the age, wealth and family status that are not available to the advertiser. Likewise, it can be difficult to properly target banner advertising if little or no information is available about the user. Consequently, a certain proportion of PPC payments doubtless relate to users who are not even eligible for (let alone interested in) the relevant product, e.g. through age or geographical location.

The above issues are symptomatic of more general practical difficulties in collecting user information over the Internet.

### SUMMARY OF THE INVENTION

Accordingly, one invention provides a method for interacting with a user over a network. The method includes receiving a request from a user machine for a content page. The request is received over a data network at a publisher web-site that hosts the content page. An interstitial page is determined from a plurality of interstitial pages, and the determined interstitial page is provided to the user machine over the data network. The interstitial page includes one or more fields for collecting information about the user and two or more user response options for selection by the user. The two or more user response options include at least a positive response and a negative response. The method further includes receiving over the data network the selected user response to the interstitial page plus any information collected about the user. The selected user response is recorded, including any negative response, and the user machine is provided with the requested content page over the data network from the publisher web-site. The recorded selected user responses for one or previous interactions with the user are then available for use in controlling any future interaction with the user.

Thus future interactions with the user are controlled or at least influenced by previous user responses (including negative user responses to an interstitial page). A wide range of potential user interactions may be so controlled, including providing further interstitial pages to the user. This allows better targeting of the future interstitial pages (e.g. as adverts) to users. The approach can also be used more broadly, for example as part of the collection of survey data from a user, to determine targets for marketing or service offers

The worldwide web, as its name implies, is built around links between pages. Users therefore become accustomed to links or buttons that navigate between pages. However, this ease of navigation provides a simple, easy and quick mechanism for a user to move on rapidly from material that is not of direct interest. An example of such a navigational button might be “skip” or “cancel”.

In contrast, the present approach involves presenting the user with an interstitial page containing specific positive and negative choices, which don't have explicit navigational meaning. It has been found that when confronted with such choices, and without an explicit quick navigational option, a user provides a more considered selection between the positive and negative choices. Accordingly, the data collected from the user is more reliable and more valuable than existing approaches, which generally focus only on positive responses. For example, since a user has to make a proactive choice between a positive response and a negative response, selection of the latter option is more meaningful than a null result obtained with a banner advertisement or sponsored link (where a user may simply ignore or overlook the relevant advert). Consequently, the information collected and stored about negative responses (which will generally represent a large fraction of the user responses provided) is valuable for future advertising and marketing activity.

In one embodiment, the publisher web-site communicates with a separate server which provides the interstitial page to the user machine. The server may support multiple different publisher web-sites. This enables data to be collected and utilised from transactions with the multiple different publisher web-sites. For example, a first request may be received at first publisher web-site, and a second request may be received later at a second publisher web-site. A determination of an interstitial page to provide to the user machine in respect of the second request may be based at least in part on a recorded selected user response for one more previous interactions with the user in respect of the first request. The system therefore supports a form of collective memory from multiple different publisher web-sites, which can then be used to improve targeting of the interstitial pages.

In one embodiment, the available user options include at least a positive response, a negative response, and an intermediate response. The intermediate response indicates a position which is currently negative but may be positive in the future—e.g. maybe later. This increased granularity for user response is difficult with conventional Internet advertising, but again helps to improve the targeting of interstitial pages.

In one embodiment, determining an interstitial page includes generating a score for each of a plurality of potential interstitial pages and identifying the interstitial page with the maximum (i.e. most meritorious) score. The score for an interstitial page may be based at least in part on a recorded selected user response for one or more previous interactions with the user in respect of that interstitial page. In particular, if a user has already been served—and declined interest in—a certain interstitial page, it may be desirable to select an alternative interstitial page to present to that user in the future. One way of achieving this is to decrease the score for an interstitial page for which the recorded user response for a previous interaction with the user is a negative response. The score can be regarded as representing the relevancy of the interstitial page to a given user.

In one embodiment, the score for an interstitial page is based on a recorded selected user response for previous interactions with the user in respect of that interstitial page in a time-dependent manner. For example, if a user has very recently declined interest in a particular interstitial page, it may be unattractive to present the page again to the user in the near future (i.e. the user is unlikely to have changed their position). However, if the user declined interest in a particular interstitial page a long time ago, it may be more attractive to present the page again to the user, since their attitude or needs may have changed since the previous presentation. In this embodiment, the score for a particular interstitial page is therefore dependent on the recency of previous actions.

In one embodiment, recording the selected user response comprises writing a cookie to the user machine. (Another approach might be based on a user-registration system or such-like). The cookie(s) may be written to the user machine via the publisher web-site. Associating the cookies in this manner with a publisher web-site known to the user may reduce the likelihood of the cookies being deleted by the user (e.g. for reasons of security or privacy).

Another embodiment of the invention involves interacting with a user over a network having multiple publisher web-sites connected thereto. The method comprises receiving a request from a user machine for a content page. The request is received over a data network at a publisher web-site that hosts the content page. The user machine is now provided with a determined interstitial page over the data network. The interstitial page includes one or more fields for collecting information about the user. The selected user response to the interstitial page plus any information collected about the user is received over the network, and the selected user response is recorded. The user machine is now provided with the requested content page over the data network from the publisher web-site. Meanwhile, the recorded user response is collated with responses from the same user obtained from others of the multiple publisher web-sites. The determination of the interstitial page to provide to the user machine is based on the collated, recorded user responses.

As noted above, sharing information between multiple publisher sites represents a form of collective memory which can then be used to improve targeting of the interstitial pages. This is attractive and more efficient for users, advertisers and publishers.

The present invention also provides an apparatus and computer program for implementing a method such as described above. The apparatus may comprise one or more computer systems under suitable program control. The computer program may comprise instructions in machine-readable form which when loaded and executed by one or more computer systems cause the computer systems to implement the method of the invention. The computer program may be provided as a computer program product, with the instructions stored on a medium such as a CD, DVD, flash ROM, etc, or supplied using a transmission medium such as the Internet.

### BRIEF DESCRIPTION OF THE DRAWINGS

Various embodiments of the invention will now be described in detail by way of example only with reference to the following drawings:

FIG. 1 illustrates a computer network in accordance with one embodiment of the invention;

FIG. 1A illustrates a computer network in accordance with another embodiment of the invention;

FIG. 2 illustrates a flowchart for a method in accordance with one embodiment of the invention;

FIG. 3 illustrates an example of an interstitial page provided in accordance with one embodiment of the invention;

FIG. 4 is a flowchart illustrating the handling of cookies in accordance with one embodiment of the invention; and

FIG. 5 is a flowchart illustrating the selection of an interstitial page in accordance with one embodiment of the invention.

### DETAILED DESCRIPTION

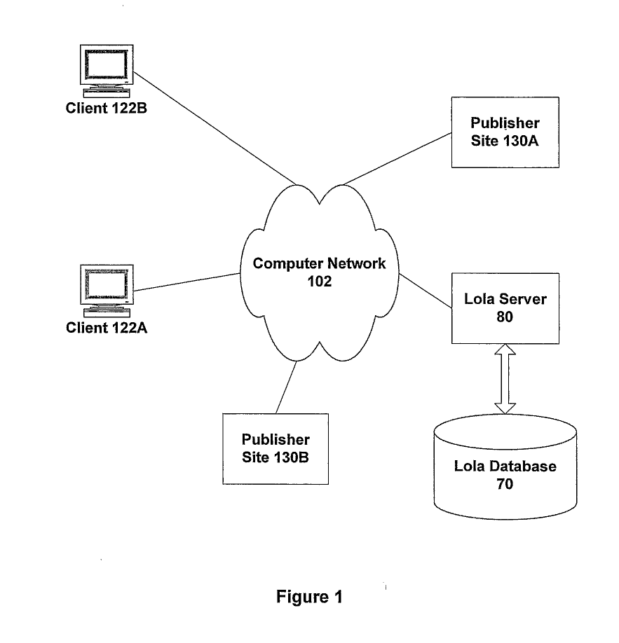

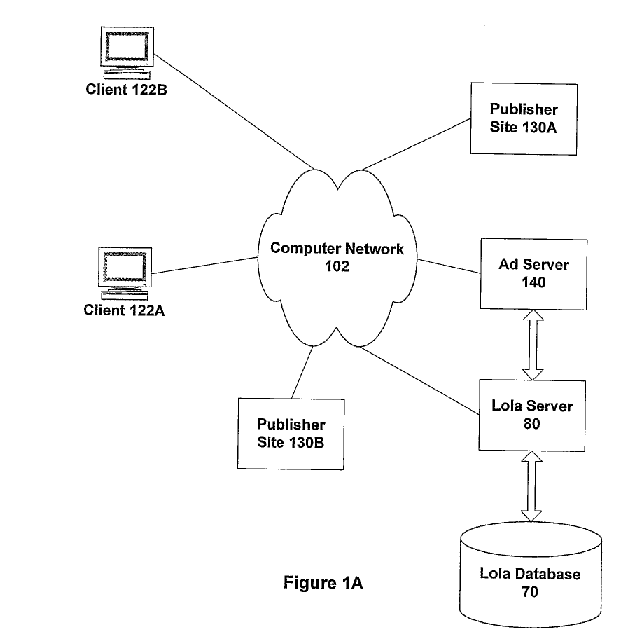

FIG. 1 illustrates various computer systems linked by a data network in accordance with one embodiment of the invention. In particular, FIG. 1 depicts the web-sites 130A, 130B of two publishers that may be accessed over computer network 102. Each web-site may be implemented by a server, a server cluster etc. Each web-site may be run directly by the publisher, or may be hosted by some third party, such as an application service provider, on behalf of the publisher. Note that publisher is used here in a general (broad) sense to indicate any organisation that makes information available over the network, and may include media companies, retailers, educational institutions, etc.

The content on the publisher web-sites 130A, 130B may be accessed by clients 122A, 122B over network 102. In one embodiment, clients 122A, 122B are conventional personal computers provided with a web browser such as Internet Explorer from Microsoft Corporation, and computer network 102 comprises the Internet (worldwide web). However, clients 122A, 122B may comprise any suitable data device, including a digital television, a PDA or other portable computer device, a mobile telephone (cellphone) with support for data access, etc. In addition, client device 122 may access a publisher web-site 130 via any suitable network(s), such as the Internet, a mobile telephone network, a digital television network, etc.

FIG. 1 also illustrates a server 80, denoted in FIG. 1 as the Lola server 80. The Lola server 80 is provided with a database 70, which may be local or remote to server 80. In one embodiment, database 70 comprises a Microsoft SQL database, while the Lola server 80 is based on the .NET platform (also available from Microsoft Corporation). However, it will be appreciated that any other suitable database and/or application platform could be used instead.

The Lola database 70 is used to store various information received by the Lola server. The Lola server 80 and database 70 may be implemented by one or more machines as appropriate. The Lola server 80 is generally able to communicate with clients 122 over the same computer network 102 as publisher web-sites 130. In addition, the Lola server can communicate with the publisher web-sites 130 over computer network 102. In some embodiments, the Lola server 80 and database 70 may be provided with separate (or additional) communications to a publisher web-site (rather than using computer network 102). In some embodiments, the Lola server 80 and database 70 may in effect be integrated into a publisher web-site 130.

In general, the skilled person will be aware of a wide range of possible modifications to the configuration shown in FIG. 1. For example, it will be appreciated that while FIG. 1 depicts only two clients and two publisher web-sites, the number of clients and the number of publisher web-sites will generally be much larger than two. In addition, publisher web-sites 130A, 130B and/or server 80 may be accessible to a wide range of client devices via multiple different networks.

FIG. 1A illustrates various computer systems linked by a data network in accordance with another embodiment of the invention. The configuration of FIG. 1A is generally similar to that of FIG. 1, except for the additional presence of ad server 140. Thus when a user contacts a publisher site 130 for a content page, the publisher site interacts with the ad server 140 which provides a banner ad for display on the content page. The ad server 140 may supply the advertisement directly to the client 122 (in effect the content page supplied by the publisher site 130 includes a link to the ad server site 140). Alternatively, the ad server 140 may provide the advertisement to the publisher site 130 for inclusion in the content page supplied by the publisher site to a client 120.

As shown in FIG. 1A, the Lola server 80 is able to communicate with ad server 140, through computer network 102 and/or through a customised link. In the embodiment of FIG. 1A, the Lola server generally interacts with the publisher sites 130 via the ad server 140, rather than directly (as for the embodiment of FIG. 1). It will be appreciated that there may be multiple ad servers 140, and the Lola server interacts with different publisher sites through different ad servers. A further possibility is that the Lola server interacts directly with some publisher sites, and interacts indirectly through one or more ad servers with other publisher sites.

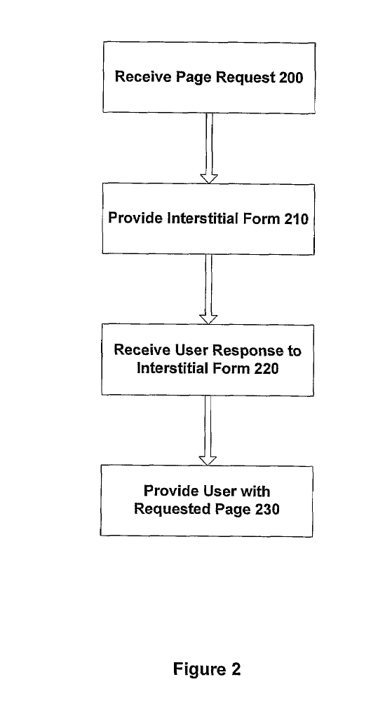

FIG. 2 is a flowchart illustrating the operation of the various computer systems of FIG. 1 and/or FIG. 1A in accordance with one embodiment of the invention. In operation 200, a publishing web-site 130 receives a request from a user (client 122) for particular content. For example, a user requests a particular web page that resides on the publisher web-site by sending an http request to the publisher web-site specifying the URL of the requested page. The requested web page may comprise any particular content—e.g. text, images, video, animation, audio, applets, etc. In addition, the requested page may represent an existing (static) page, or a dynamic page that is to be assembled or generated by the publisher web-site in response to the particular user request (URL). In many situations, the user will already be accessing material from the publisher web-site, so the request of operation 200 will commonly comprise the user selecting a hyperlink within the previously provided material, where the hyperlink specifies some other page on the publisher web-site.

However, rather than the publisher web-site directly providing the requested material to the client browser, at operation 210 an interstitial form is provided to the client instead. In this context, interstitial implies that the material is inserted into a sequence of web pages received by the client. In other words, by submitting the request at operation 200, the user is expressing a desire to move from an original page (which might be the user's startup or home page, another page on the publisher web-site, or some third party page, for example a search engine or directory) to the requested page. The interstitial page is provided to the user as they leave the original page, but before they receive the next requested page—i.e. the page that the user has requested to follow directly the original page. Accordingly, the interstitial page is not part of the normal flow of web pages for a site, but rather is injected into the sequence of pages requested by the user.

The user provides a response to the interstitial page at operation 220. This response may include user data, as described in more detail below, which may be stored into the Lola database 70. The user can then be re-directed to the web page that they originally requested at operation 230.

The decision as to whether or not to provide the interstitial page to the user (instead of the requested page) at operation 210 is generally made by the publisher web-site that receives the request at operation 200. Another possibility is that the decision is made by ad server 140, which has an arrangement to supply advertising material to publisher web-site 130.

The decision itself may be determined based on a variety of factors, such as listed in Table 1 below.

TABLE 1
A random element - e.g. 1% of all requests might be intercepted in this manner on a
random basis
The requested URL (page) - e.g. a request for a particular URL might always trigger
the provision of an interstitial page
The IP address of user - in many cases this can be used to provide some indication of the
geographical location of the user, for example if the user is allocated a dynamic IP
address by a local switch in a telecoms network, where each switch has a known set of
IP addresses to allocate; in a current implementation, geolocation is obtained via a
system from MaxMind (see www.maxmind.com), but other geolocation systems
could also be used, such as that from Quova (www.quova.com)
Specific user information - available for example if the user has previously registered
at the publisher web-site, such as to make a purchase from the site. Factors such as
user name, age, address, sex, occupation, previous spending habits, etc might be
employed
Current date and/or time
Current load factors with the system(s) of FIG. 1/1A
Information about the browser and/or link to the user - e.g. if the user has a very slow
connection speed, it may be undesirable to provide them with additional (unrequested)
information.
Availability of material to go into the interstitial page

It will be appreciated that the factors set out in Table 1 are for illustration only, and in some cases a decision may be based on a factor or factors not listed in Table 1—for example, previous URLs visited at the publisher web-site (if tracked) and/or behavioural records which may be obtained from a third party supplier. In addition, in some cases a decision may be based on multiple factors (whether or not included in Table 1).

The mechanism for providing the interstitial form to the user may vary according to the particular implementation. In one embodiment, the interstitial page is provided to the client 122 by the Lola server 80. This is accomplished by having the publisher web-site 130 forward the client browser 122 to the Lola server 80 (using the http re-direct facility). In another embodiment, the interstitial page is provided to the client 122 by the publisher web-site itself 130. This may involve the publisher web-site integrating (or interacting with) the Lola server 80, either directly (as for the embodiment of FIG. 1), or indirectly through ad server 140 (as for the embodiment of FIG. 1A).

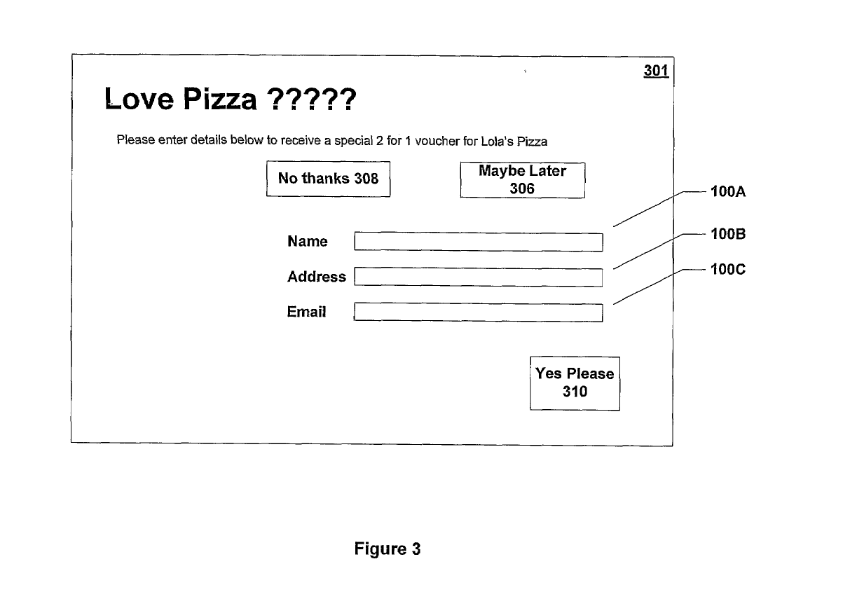

FIG. 3 illustrates one example of an interstitial page 301 as provided to a user at operation 210. This page represents a form, in that it includes entry fields 100A, 100B, 100C for the name, address and email of the user. The page also includes an advertising message for a pizza firm. The message indicates that if the user completes the form, he/she will receive a special offer coupon from the pizza firm.

The interstitial page also includes three entry buttons, a No Thanks button 308, a Yes Please button 310, and a Maybe Later button 306. The No Thanks button will generally be selected by the user if they are not interested in the advertised offer, and so represents a negative response. Alternatively, the Yes Please button will generally be selected by the user if they are indeed interested in the advertised offer, and so represents a positive response. The third button, Maybe Later 306, is described in more detail below.

It is expected that a user who selects the No Thanks button will not have completed the entry fields, whereas a user who selects the Yes Please button will have completed the entry fields. If a user who selects the No Thanks button has in fact completed one or more entry fields, these may be discarded, or the user may be prompted to confirm whether or not they want to sign up for the offer. If a user who selects the Submit button has not completed the entry fields, then an error message can be displayed informing the user that they need to provide the requested information in order to obtain the offer (the omitted field(s) may also be highlighted).

The interstitial page of FIG. 3 is primarily intended for marketing or advertising purposes. However, the interstitial form can also be used more generally to acquire user data, for example for a wide variety of survey or polling purposes. An interstitial page can include any appropriate material in addition to the user data entry fields, such as text, images, animation, sound, and so on.

In contrast with conventional Internet advertising, such as banner adverts and sponsored links, the interstitial page is not directly competing for attention with other material that may be of more immediate interest to the user. Accordingly, the interstitial page will receive proper attention and consideration from a user. In addition, since the interstitial page represents a direct and immediate opportunity to collect customer data, it can provide an advertiser with a much better quality of leads. In other words, if a user is prepared to complete the entries fields 100A, 100B, 100C, this generally indicates a higher level of interest than for a conventional PPC approach. Furthermore, since the advertiser can collect user contact information (as per the example of FIG. 3), this allows the advertiser to pursue the lead proactively in the future, rather than having to wait for any further customer activity.

The screen of FIG. 3 does not include any explicit option for further navigation (such as “skip” or “cancel”). This has been found to force the user to make a proactive choice between the different available responses, in particular buttons 306, 308 and 310. As a result, the selection of the No Thanks button 308 to provide a negative response is more significant than a mere null result obtained with a banner advertisement or sponsored link, where a user may simply have ignored or overlooked the relevant advert in order to view or proceed to the desired material. Consequently, the information collected and stored by the Lola server about a negative response is valuable for future advertising and marketing activity. In contrast, for many existing advertising systems, no information is obtained or recorded about null responses, despite these normally representing the large majority (often >99%) of user outcomes.

In some implementations, the same interstitial page may be provided to all users. In other implementations, a variety of material is available for the interstitial page, and a decision is made as to which material (e.g. advert) to include in the interstitial page. This decision can be based on a wide variety of factors, including those set out in Table 1 above. For example, if it is known that the user has been re-directed from a publisher URL relating to automobiles, the interstitial page may advertise a new car, and ask if the user is interested in signing up for a test drive.

Another factor that may be used to determine the material for interstitial page 301 is the revenue opportunity. For example, for each set of user details collected by the Lola server 80 via interstitial page 301, the operator of the Lola server 80 may receive a payment from the promoter or advertiser of the interstitial page (Lola's Pizza in the example of FIG. 3). This is somewhat analogous to the pay-per-click model of conventional Internet advertising, except that the quality of leads or prospects for the advertiser is much higher than PPC (and therefore much more valuable). This is firstly because of a higher level of user interest, as indicated by the user having specifically entered their personal information into the interstitial page, and secondly because the collected data can assist in driving the user transaction to completion. An alternative approach is for the advertiser to pay on the basis of each interstitial page 301 served to clients. Another possibility is to combine the above two approaches, so that the advertiser pays a first (relatively small) amount for each interstitial page served to a client, and a second (relatively large) amount for each set of user data collected (i.e. for each positive response to the interstitial page).

If the Lola server includes a PPC type model—i.e. a payment for each set of user data collected, one option is for the Lola server 80 to select the material for interstitial page 301 based on the highest yield. The yield for a given advert is determined (analogous to PPC arrangements) by multiplying the payment for each data set obtained for that advert with the percentage of interstitial pages for that advert which result in acquisition of user data (and hence a payment). For example, if a given advertiser pays £20 for each set of user data obtained, and 2% of clients respond with user data to the interstitial page for the advertiser, the yield is £400 (allowing for the fact that yields are normally calculated on the basis of a cost per thousand customers).

The payment for user data is generally made by the advertiser to the operator of the Lola server 80 (which collects the user data). The operator of the Lola server 80 can then forward a proportion of the payment to the publisher of the web-site 130A, 130B that directed the client to the Lola server 80 for providing the interstitial page 301. This then provides an incentive for the publisher web-sites 130A, 130B to participate in the arrangement of FIG. 1. (In the embodiment of FIG. 1A, the operator of the ad server 140 may also receive a cut of the revenue).

The Lola server 80 tracks, for each set of user data collected, the particular web-site from which that client was re-directed to the interstitial page. This then allows payments to a publisher to be directly linked to the yield from clients forwarded from that publisher. Furthermore, an advertiser can determine the quality of leads from different publishers. For example, an advertiser may find that users directed from a particular publisher web-site are most likely to progress from providing data on the interstitial page to becoming customers of the advertiser. The advertiser may then be prepared to make a higher payment for leads from this publisher than for leads from other publishers. In other words, the advertiser can discriminate the quality of leads from different publishers.

In many cases, the financial arrangements between a publisher and the operator of the Lola server may depend on (e.g. mirror) the financial arrangements between the operator of the Lola server and the advertiser. For example, the operator of the Lola server may pass on to the publisher a fixed amount (say 60%) of all payments from the advertiser arising from re-directs from the web-site of that publisher.

In an alternative implementation, for any given interstitial page, the system can track the origin of clients receiving that page in terms of the percentage from each publisher. The revenue (yield) obtained from that page can then be shared between the publishers in accordance with the percentage of clients re-directed from that publisher to the relevant page. This approach rather favours publishers who forward a large number of users, irrespective of whether those users then provide their user data (or represent high quality leads).

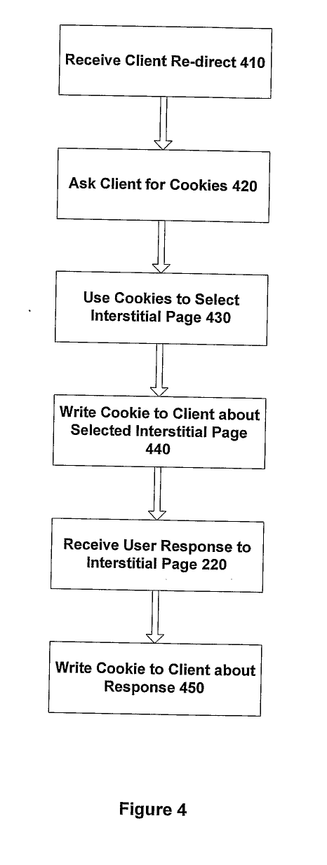

FIG. 4 illustrates the handling of client cookies by the Lola server 80 in accordance with one embodiment of the invention. The method starts at operation 410 when the Lola server 80 receives a browser re-direct for a client 122 from a publisher web-site 130. At operation 420, the Lola server 80 communicates with the client 122 to find out if the client has any cookies previously stored on the client by the Lola server. The received cookie information can be saved to Lola database 70 if so desired. At operation 430, the Lola server uses the cookie information (if any) obtained from the client to determine which interstitial page or advertisement to provide to the client. This determination is described in more detail below.

At operation 440, when the interstitial page is provided to the client (corresponding to operation 210 in FIG. 2), the Lola server also stores a cookie to the client on the client. The cookie records the identity of the interstitial page that is provided to the client. At operation 220 (as per FIG. 2), the user response to the interstitial page is received by the Lola server. This prompts the Lola server to write a further cookie representing the response onto the client system at operation 450. The client is now re-directed by the Lola server 80 back to the initial publisher web-site 130 to provide the client with the originally requested page (as per operation 230 of FIG. 2).

If this is the first time that a given client has interacted with the Lola server 80, then the request of operation 420 will not yield any cookies, but it will store cookies to the client at operations 430 and 450. These cookies are then available for retrieval during subsequent interactions between the client and the Lola server. Consequently, when a client is re-directed to the Lola server, the Lola server can determine from the cookies stored on the client which interstitial pages 301 have previously been provided to the client, and also the user response to those pages. This information can then be used in selecting which particular advert or interstitial page to provide to the client.

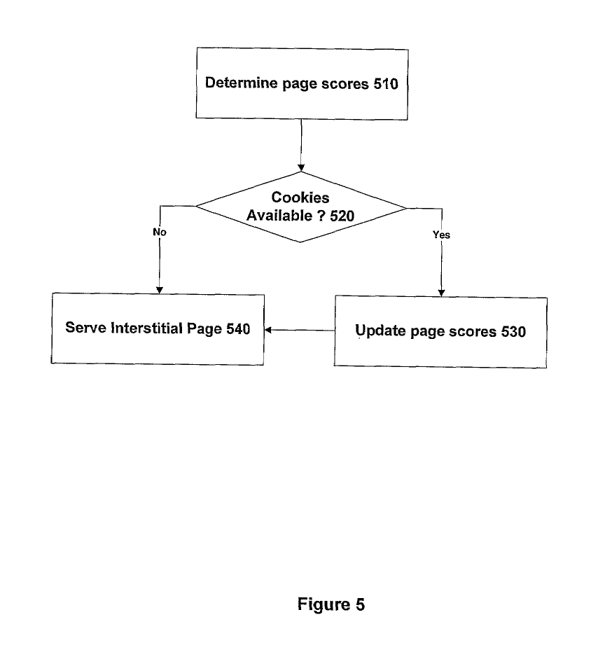

FIG. 5 provides a flowchart of the procedure used by the Lola server 80 for using cookie information to select which interstitial page to serve to a client in accordance with one embodiment of the invention. The selection of FIG. 5 is based on a scoring algorithm, although other embodiments may use a different approach.

The flowchart of FIG. 5 commences with determining a score for each potential interstitial page, e.g. advert (operation 510). The score might be determined from one or more factors, such as yield, the factors listed in Table 1, and so on. If no particular information is available about a particular client, the determination might be based on average performance or market norms. For example, it might be known from references from one publisher web-site that the yield for a given interstitial page is generally high, so that this page would have a high score for references from a new publisher web-site. It might also be known that adverts for a first advertiser normally provide a higher yield than adverts for a second advertiser. Information for determining the score may be stored in Lola database 70.

It is now determined (operation 520) whether any cookies have been retrieved from the client (as per operation 420 of FIG. 4). If so, the previously determined scores are updated based on the cookie information (operation 530). The best scoring page is now served to the client (operation 540).

As an example of the use of cookie information to update scoring information, if a user has recently signed up to an advert to test drive a car, it would not normally be sensible to offer them this same advert again. This helps to prevent advertisers paying twice for the same lead information (in contrast with PPC for conventional Internet advertising). On the other hand, this user may now be of particular interest to other car manufacturers for offering a test drive of their competitor vehicles. Accordingly, the cookie information would decrease the score for the original advert, but increase the score for competitor adverts.

In some cases, if there has been a positive response previously to a particular advert, this may increase the desirability of repeating the advert to the user. For example, if a client has subscribed to the pizza voucher offer shown in FIG. 3, the advertiser may be happy to target further voucher offers at this user—whether repeats of the original offer or some new offer.

This sort of approach is especially powerful if the Lola server 80 has further information about the client. For example, the cookie may store a unique reference number for a voucher provided to the client. If a voucher having this unique reference number is redeemed, and the advertiser provides this data to the Lola server 80, this information can be used to enhance the score should this client return to the Lola server (the client would be identified by the cookie with the unique reference number).

The influence of previous responses on the scores may be time-dependent. For example, if a user has recently specifically declined interest in a particular advert, it may not make sense to show them that advert again in the immediate future. In other words, this negative response will reduce the score for the advert (interstitial page) concerned. However, this reduction in score may decrease with time. Consequently, if a user was shown (and declined) an advert, then after a sufficient passage of time, e.g. many months, this circumstance would no longer count (or count strongly) against the selection of this advert to show again to the user.

It will be appreciated that the score for an advert may not necessarily be reduced the first time that it is declined (or may only be reduced a little bit at this stage). However, if there are further rejections of the same advert by the same user, this may then rapidly decrease the score for serving this advert to the user (at least for the immediate future).

One possibility is that if a user has previously (recently) rejected a particular interstitial page, the next time that the user accesses the Lola server, an improved version of the same offer is provided to the user. For example, analogous to the interstitial page shown in FIG. 3, an initial version of a page might provide a £2 money off voucher. If the user does not accept this offer, the next time that the user is provided with the page, the offer might be increased to a £3 money off voucher. A user might therefore receive a sequentially improving set of offers. In other words, the interstitial page may evolve or adapt depending on the actions of a user.

In one implementation, the Lola server determines a profile for each user. The profile can be based on known approaches, such as a target group index (TGI). For any given user, the profile may be determined or updated using any available information, for example geolocation, specific user information (e.g. obtained from a registration process), and/or cookie information placed in respect of previous pages served to the user by the Lola server 80. The profile may include data such as car owner (and if so, make and model), cat owner, etc. In effect, the profile may represent a set of scores which are adjusted according to the available information. The determination of whether or not to serve a particular advert to a user can then be based on the profile score for the TGI associated with that advert. For example, if it is determined that a user is not a car owner, the profile score in respect of car insurance adverts may be significantly decreased. This represents a form of elimination targeting (also known as avoidal targeting).

As previously noted, the interstitial page of FIG. 3 includes a “Maybe Later” button 306. This can be used by a client to indicate that they do not want to provide their details at present, but might be interested in the offer or advert at a later time. If such a response has been obtained from a user and stored as a cookie at operation 450, this information can then influence the Lola server 80 in determining which advert to serve to the client next time they interact with the Lola server 80. Therefore, in the implementation of FIG. 5, if a “Maybe Later” response is recorded for a user with respect to a particular advert, this information may increase the score for that advert, thereby enhancing the likelihood of it being shown again soon to the user.

In the embodiment of FIG. 1, the Lola server 80 (and database 70) receives re-directs from multiple publishing web-sites. The transactional history used when making the determination of which advert to show (based on previous responses) is effective across all these publishing web-sites. In other words, if a user accessing publisher web-site 130A declines a particular advert from the Lola server 80, and is subsequently re-directed to Lola server from publisher web-site 130B, the Lola system knows about the prior interaction with the user, and can factor this into the decision as to which interstitial page to provide to the client.

Accordingly, if a user has already provided a definitive response to a particular advert from a first publisher site (e.g. by expressing zero interest, or by expressing positive interest and providing contact details) the Lola system can determine a different advert to provide to the user. This is attractive for a user, in that they do not have their time wasted with irrelevant or inappropriate material; instead, the system of multiple publishers operates as a coherent (and more intelligent) whole. The arrangement is also attractive for advertisers in that they do not (unknowingly) repeat the same advert multiple times to the same client. This improves advertising efficiency and also reduces costs (as well as avoiding the risk of the client becoming disgruntled with the advertiser).

Advertisers therefore have an incentive to work with those publishing web-sites that are involved with the Lola server 80. This in turn encourages publishers to become part of the collective arrangement, which helps to provide increased reach and relevancy for an advert: reach, because the advert can be placed with more publishers, thereby achieving greater penetration, and relevancy, because user information from multiple publishers can be collated to improve the targeting of advertisements.

In the configurations so far described, the user selects a publisher web-site 130, but the cookies are provided by the Lola server 80. Since the user has not explicitly accessed the Lola server 80, these cookies are regarded as third party cookies, compared to cookies from the publisher web-site, which are second party cookies (since this party is directly known to the client). There is an increased likelihood of third party cookies being deleted from a machine, whether through ad hoc review by a user, or automatically, based on security settings of the machines.

Accordingly, one embodiment of the invention adopts an approach based on second party cookies from the publisher web-site. There are various ways in which this can be implemented. For example, rather than the Lola server writing cookies itself back to the client, the Lola server could request the publisher server 130 to which the client is re-directed to write the cookies (as part of operation 230).

In order for these cookies to be available when the user accesses other publisher web-sites, the screen 301 of FIG. 3 could be made to incorporate small components from the different publisher web-sites (these components may be transparent to the user, background objects or text etc). As each publisher web-site is contacted in relation to its respective component(s), the publisher web-site reads any second party cookies stored on the client machine from that particular publisher web-site. This information is then passed to the Lola server for use in determining which interstitial page to serve to the client.

Although the system described so far uses cookies to record previous activity, in another embodiment, this procedure may be based on a user identifier, for example acquired by user registration at a publisher web-site 130. Thus the Lola server 70 can determine which interstitial pages have previously been provided to the identified user based on information stored in the Lola database 70, and then select an interstitial page to serve to the user accordingly.

It will be appreciated that whichever method is employed for user identification does not have to be perfect—i.e. completely reliable. For example, in a system based on third party cookies, if these are deleted for a particular user, the risk is that the user may repeatedly receive the same advert, even if they have always declined it previously. Although this reduces the expected efficiency (and yield) of the advertising, many of the benefits of the system are nevertheless retained (such as the potential to acquire specific user contact information).

In the above embodiments, the Lola server provides the interstitial pages to the user for data collection. However, in other embodiments, the interstitial page may be provided to the user from the publisher system. Thus in such an embodiment, a user is re-directed to the Lola server as previously described. The Lola server then makes a determination of which advert should be shown to the user, e.g. based on relevancy, recency, etc., using any cookie(s) from the user and/or other available information. The Lola server then returns this information to the publisher web-site for serving the advert to the user. (In some cases the publisher web-site may already have the advert, while in other cases, the publisher web-site may need to first obtain the relevant advert from the Lola server). Another possibility is that the Lola server acts through (and in conjunction with) an ad server 140, as described above in relation to FIG. 1A.

In the embodiments described above, the information obtained via the interstitial pages is used for determining which interstitial page to provide to a user for a subsequent interaction with the Lola server. The information may also be used for deciding more generally on advertising to provide to a user—e.g. the subsequent interstitial page might comprise a video advertisement or other form of advertisement, without specific data collection. Moreover, the collected information might also be employed by the Lola server to determine which sponsored link or banner advert to provide to a user. For example, in this latter configuration, a publisher web-site or ad server might communicate with the Lola server to determine which banner advert to provide to a user based on profile information available to the Lola server from a previous interstitial page. The information may also be used in a more general context to control future interactions with the user. For example, the information may be used to determine whether the user should be included in future surveys, marketing offers, and so on. It will be appreciated that the future interactions with the user can be linked back to the information for that user from previous responses based on the recorded cookie information.

In conclusion, a variety of particular embodiments have been described in detail herein, but it will be appreciated that this is by way of exemplification only. The skilled person will be aware of many further potential modifications and adaptations that fall within the scope of the claimed invention and its equivalents.

1-15. (canceled)

16. A method for interacting with a user over a network comprising:
receiving a request from a user machine for a content page, wherein said request is received over a data network at a publisher web-site that hosts said content page;
determining an interstitial page to provide in response to the request;
providing the user machine with the determined interstitial page over the data network, said interstitial page including one or more fields for collecting information about the user and two or more user response options for selection by the user, said two or more user response options including at least a positive response and a negative response;
receiving over the data network the selected user response to the interstitial page plus any information collected about the user;
recording the selected user response; and
providing the user machine with the requested content page over the data network from the publisher web-site;
wherein recording the selected user response includes recording each negative response, the recorded negative responses for one or more interactions with the user being available for use in controlling a future interaction with the user.

17. The method of claim 16, wherein the publisher web-site communicates with a separate server which provides the interstitial page to the user machine.

18. The method of claim 17, wherein said separate server is involved in said future interaction with the user.

19. The method of claim 16, wherein a first request is received at first publisher web-site, and the future interaction is between the user and a second publisher web-site, and wherein future interaction is based at least in part on a recorded selected user response for one more previous interactions with the user in respect of the first request.

20. The method of claim 16, wherein said two or more user response options include at least a positive response, a negative response, and an intermediate response, wherein said intermediate response indicates a position which is currently negative but may be positive in the future.

21. The method of claim 16, wherein said future interaction comprises receiving a further request from the user machine for a content page, said further request being received over a data network at a publisher web-site that hosts said content page; and determining another interstitial page to provide in response to the further request.

22. The method of claim 21, wherein a first request is received at first publisher web-site, and a second request is later received at a second publisher web-site, and wherein the determination of the interstitial page to provide to the user machine in respect of the second request is based at least in part on a recorded selected user response for one more previous interactions with the user in respect of the first request.

23. The method of claim 21, wherein determining an interstitial page to provide to a user includes generating a score for each of a plurality of potential interstitial pages and identifying the interstitial page with the maximum score, and wherein the score for an interstitial page is based at least in part on a recorded selected user response for one or more previous interactions with the user in respect of that interstitial page.

24. The method of claim 23, further comprising decreasing the score for an interstitial page for which the recorded user response for a previous interaction with the user is a negative response.

25. The method of claim 23, wherein the score for an interstitial page is based at least in part on a recorded selected user response for one or more previous interactions with the user in respect of that interstitial page in a time-dependent manner.

26. The method of claim 16, wherein recording the selected user response comprises writing a cookie to the user machine.

27. The method of claim 26, wherein the cookie is written to the user machine via the publisher web-site.

28. A method for interacting with a user over a network having multiple publisher web-sites connected thereto, said method comprising:
receiving a request from a user machine for a content page, wherein said request is received over a data network at a publisher web-site that hosts said content page;
determining an interstitial page;
providing the user machine with the determined interstitial page over the data network, said interstitial page including one or more fields for collecting information about the user;
receiving over the data network the selected user response to the interstitial page plus any information collected about the user;
recording the selected user response;
providing the user machine with the requested content page over the data network from the publisher web-site; and
collating the recorded user response with responses from the same user obtained from others of said multiple publisher web-sites;
wherein the collated, recorded user responses are available to control a future interaction between the user machine and said multiple publisher web-sites.

29. A computer system for interacting with a user over a network, said computer system comprising:
means for determining an interstitial page in response to a request received from a user machine for a content page, wherein said request is received over a data network at a publisher web-site that hosts said content page;
means for providing the user machine with the determined interstitial page over the data network, said interstitial page including one or more fields for collecting information about the user and two or more user response options for selection by the user, said two or more user response options including at least a positive response and a negative response;
means for receiving over the data network the selected user response to the interstitial page plus any information collected about the user; and
means for recording the selected user response, wherein said recording includes recording each negative response, the recorded negative responses for one or more interactions with the user being available for use in controlling a future interaction with the user.

30. A computer-readable storage medium storing instructions that when executed by a computer cause the computer to perform a method for interacting with a user over a network, wherein the method comprises:
receiving a request from a user machine for a content page, wherein said request is received over a data network at a publisher web-site that hosts said content page;
determining an interstitial page to provide in response to the request;
providing the user machine with the determined interstitial page over the data network, said interstitial page including one or more fields for collecting information about the user and two or more user response options for selection by the user, said two or more user response options including at least a positive response and a negative response;
receiving over the data network the selected user response to the interstitial page plus any information collected about the user;
recording the selected user response; and
providing the user machine with the requested content page over the data network from the publisher web-site;
wherein recording the selected user response includes recording each negative response, the recorded negative responses for one or more interactions with the user being available for use in controlling a future interaction with the user.
